(19) United States
(12) Patent Application Publication
(10) Pub. No.: US 2004/0107115 A1
(43) Pub. Date: Jun. 3, 2004

(54) Transaction voucher management method and transaction voucher management program

(75) Inventors: Yoshiyuki Takano, Kawasaki (JP); Isamu Kawamura, Kawasaki (JP); Yoshiyuki Terai, Kawasaki (JP); Nobuya Nagata, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/717,866

(22) Filed: Nov. 19, 2003

(30) Foreign Application Priority Data
Nov. 29, 2002 (JP) 2002-346833

(51) Int. Cl. G06F 17/60

(52) U.S. Cl. 705/1; 705/39; 705/7

(57) ABSTRACT

To provide a transaction voucher management method and a transaction voucher management program enabling consistency checking at an early stage in regard to a work process procedure of a transaction performed between business applications, easy addition or modification of the work process procedure when necessary, and unified management of a transaction voucher history in regard to a plurality of business applications.

In a system storing a definition data in which a work process procedure based on transaction vouchers transferred between business applications is defined in advance, and relaying the transmission of the transaction vouchers, consistency of the work process procedure is checked with regard to a received voucher, based on the definition data and a log data of the voucher having been received previously. When it is decided the consistency is retained, a log data is recorded and stored in regard to the received voucher, and also the transaction voucher concerned is transmitted to a business application of the other transaction party.

### BACKGROUND OF THE INVENTION

1. Field of the Invention

The present invention relates to a method for managing a transaction voucher transferred between business applications, and more particularly a transaction voucher management method and program enabling a consistency check, etc. based on a work process procedure.

2. Description of the Related Art

In recent years, because of the widespread use of the Internet and network technology improvement, there have been increased cases of business applications implemented in computer systems, transacting business with each other by directly communicating through a network. For example, in the commodity sales business, vouchers such as a quotation request slip, a quotation slip, etc. necessary for performing the business are exchanged, in the form of electronic data, between the business applications respectively provided on the sales side and the purchase side, and thereby the business proceeds. Such transactions between business applications are performed inside a company, between different companies, or between a company and a consumer.

In such an electronic transaction, it is necessary to check whether the business work proceeds based on a correct procedure related to the business concerned, considering a work process procedure performed in the business application on the other transaction party as well. In other words, whether necessary vouchers (necessary data in the vouchers) are transmitted/received according to the correct procedure. Such a consistency check related to the work process procedure has been performed in a relevant program independently for each business application.

Further, when performing a transaction with other plurality of business systems or business applications, it is necessary to transmit voucher data in a data format consistent with each business application or business system provided in the other party. Also, for the voucher reception side, it is necessary to receive the data in a converted data format suitable for the own business application in the reception side. To cope with these requirements, in some cases, an independent system dedicatedly performing the above-mentioned data conversion function is implemented between the business systems or the business applications, separately from each business system or business application concerned. For example, in the patent document shown below, there is disclosed a cooperation method between systems, in which a processing content such as the aforementioned data conversion is selected and executed, so that a data matches with both the systems on the originating side (cooperation initiation side) and the receiving side (cooperation acceptance side) of a transaction.

[Patent Document 1]

Japanese laid Open Patent 2002-298072.

However, in any case according to the above-mentioned conventional method, a consistency check related to the above-mentioned work process procedure, in other words a sequence check for the transaction vouchers to be exchanged between business applications, is performed in each business application. Accordingly, even if an error occurs in such a consistency check, the error cannot be detected until the business application program is executed. Therefore, it is difficult to detect such an error at an early stage.

Moreover, when addition or modification becomes necessary in a work process procedure, for example when a transaction voucher to be exchanged is newly added, program modification is required in the business applications against the processing related to the modified voucher. At the same time, program modification related to the above-mentioned consistency (sequence) check is also required against the voucher concerned. Meanwhile, in a program such as a business application program, usually the program portion related to the above-mentioned consistency check does not have an independent structure. The above-mentioned program modification related to the consistency check must be performed carefully, taking into consideration relations to many other processing portions, and such modification work is not easy.

Further, according to the conventional method, although the history of transactions having been processed can be grasped on an application-by-application basis, it has not been possible to manage the entire transactions as a whole in a unified way, when a plurality of systems are provided, or a plurality of business applications are provided in one company.

### SUMMARY OF THE INVENTION

Accordingly, it is an object of the present invention to provide a transaction voucher management method and a transaction voucher management program, which enable checking the consistency related to a work process procedure performed between business applications in an early stage, easily coping with a case of addition or modification arising in the work process procedure, and managing the history of the transaction vouchers for a plurality of business applications in a unified way.

According to one aspect of the present invention to attain the aforementioned object, in a system relaying the transmission of transaction vouchers, and storing a definition data defining in advance a work process procedure based on transaction vouchers to be transmitted between business applications, a consistency check of a received voucher with regard to the work process procedure is performed based on both the above-mentioned definition data and a log data of the transaction vouchers having been received before. When the consistency check results in consistency, a log data for the received transaction voucher is recorded and stored, and also the transaction voucher concerned is transmitted to a business application provided on the other party. Therefore, according to the present invention, because the consistency is checked before the transmitted transaction voucher is processed in the business application provided on the other party, an error can be detected at an early stage. For the modification of the system with regard to the consistency check when a work process procedure is modified, only the aforementioned definition data is required to modify. Therefore, program modification in each business application becomes easy. Further, because transaction history of the entire business applications, of which transmission of a transaction voucher is relayed, are recorded in the aforementioned transaction voucher management system, transaction history management can be performed in a unified way.

Also, in order to attain the aforementioned object, according to another aspect of the present invention, there is disclosed a transaction voucher management method in a computer relaying a transaction voucher data transmitted between business applications through a network. The method includes; a first step in which the computer receives the transaction voucher data transmitted from the business application; a second step in which the computer checks the consistency of the received transaction voucher data with regard to a work process procedure, based on both a definition data defining in advance the work process procedure performed by transmitting the transaction voucher data, and a log data having recorded information related to the transaction voucher data received in the past; a third step in which, on deciding that there is a consistency by the check performed in the second step, the computer records the information related to the received transaction voucher data as the log data, and transmits said transaction voucher data to the business application provided on a destination side; and a fourth step in which, on deciding that there is an inconsistency by the check performed in the second step, the computer performs error processing.

As a preferred embodiment of the present invention, the consistency check in the above-mentioned second step includes; a step in which the computer determines a preceding transaction voucher data to have been processed prior to the processing of the received transaction voucher data, based on the definition data; and a step in which the computer checks whether the information related to the determined preceding transaction voucher data is recorded as the log data.

As another preferred embodiment of the present invention, the information recorded as log data in the above-mentioned third step includes information for identifying a work performed based on the received transaction voucher data.

Further scopes and features of the present invention will become more apparent by the following description of the embodiments with the accompanied drawings.

### BRIEF DESCRIPTION OF THE DRAWINGS

FIG. 1 shows a configuration diagram of an embodiment of the transaction voucher management system to which the present invention is applied.

FIG. 2A shows a diagram illustrating a work sequence, in which a work flow performed between business applications are exemplarily shown.

FIG. 2B shows a diagram illustrating a work sequence, in which relation between a voucher and a preceding voucher is shown.

FIG. 3A shows a diagram illustrating a sequence definition data 100.

FIG. 3B shows a diagram illustrating sequence definition data 100 in regard to work steps exemplarily shown in FIGS. 2A, 2B.

FIG. 4 shows an exemplary data items in a sequence log data 101.

FIG. 5 shows a flowchart illustrating an exemplary operation procedure in case of setting sequence definition data 100 by a definition management section 11.

FIG. 6 shows a diagram exemplarily illustrating the actions and the sequence thereof to be performed in each work type.

FIG. 7 shows a flowchart exemplarily illustrating the processing content performed in this transaction voucher management system 1, when a transaction is being performed between business applications.

FIG. 8 shows a diagram exemplarily illustrating data items included in a voucher data 5.

FIG. 9 shows a flowchart illustrating the processing performed by a voucher processing section 12 in detail.

### DETAILED DESCRIPTION OF THE PREFERRED EMBODIMENTS

The preferred embodiment of the present invention is described herein after referring to the charts and drawings. However, it is to be noted that the scope of the present invention is not limited to the embodiments described below. In the accompanied figures, identical reference numerals or reference symbols refer to identical or like parts.

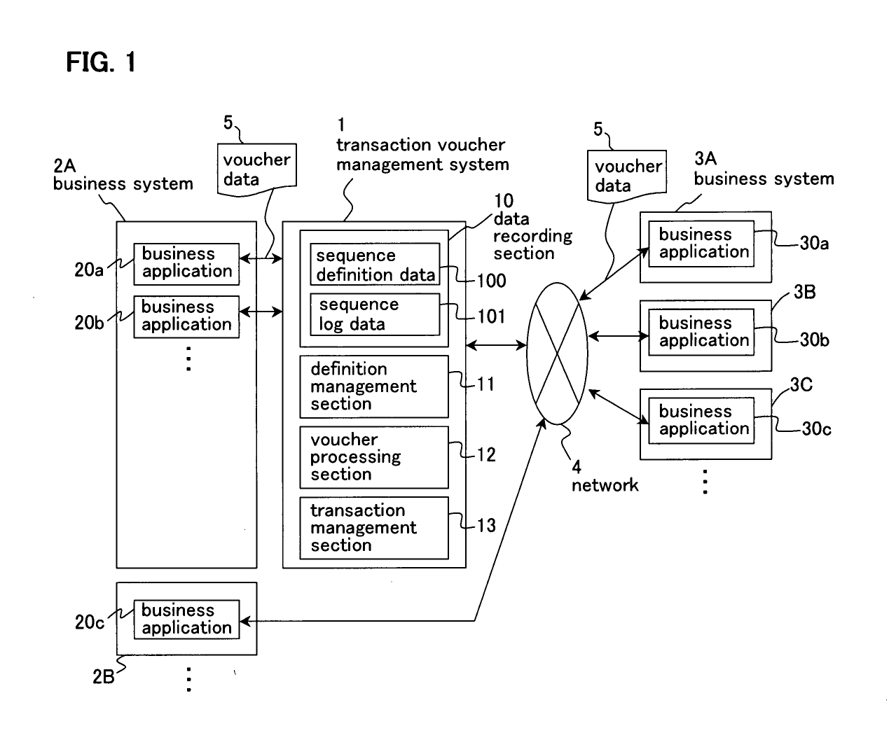

FIG. 1 shows a configuration diagram of an embodiment of the transaction voucher management system to which the present invention is applied. As shown in FIG. 1, a transaction voucher management system 1 according to the embodiment of the present invention is provided together with a business system 2A in a certain company. Transaction voucher management system 1 is a system prepared for the above-mentioned business system 2A for relaying the transaction performed between business applications (20a, 20b, . . . ) in the business system 2A concerned and business applications (30a, 30b, 30c, . . . ) provided in business systems (3A, 3B, 3C, . . . ) of another company, or a business application 20c provided in another business system 2B of the identical company. More specifically, transaction voucher management system 1 relays the transfer of voucher data 5 transmitting between the above-mentioned business applications, and performs the consistency check related to the work process procedure of this voucher data 5 in an integrated manner on behalf of the business application.

The above-mentioned business system 2A is a computer system performing a variety of business work such as purchase, sales, inspection, personnel management, etc. by a plurality of business applications (20a, 20b, . . . ) provided. Business applications (20a, 20b, . . . ) are applications executing processing related to each business work, each consisting of a program describing processing for execution, a control unit executing processing based on the program, data necessary for the processing, etc. Each business application (20a, 20b, . . . ) transmits/receives necessary voucher data 5 between the business application itself and business applications (30a, 30b, . . . ) provided in the other transaction party. Also, a business system 2B is a system similar to business system 2A, having a similar business application 20c. According to this embodiment of the present invention, transaction voucher management system 1 is provided against business system 2A. Accordingly, from the viewpoint of business applications (20a, 20b, . . . ), business application 20c is regarded as a business application provided in the other transmission party, even though business system 2A and 2B are provided in an identical company.

Also, with regard to business systems (3A, 3B, 3C, . . . ) provided in the other company, or business applications (30a, 30b, 30c, . . . ) respectively provided in these business systems (3A, 3B, 3C, . . . ), these systems or applications have the same configurations and functions as in the case of business system 2A. In addition, a network 4 shown in FIG. 1 is constituted of the Internet or the like, through which voucher data 5 are transmitted/received between the above-mentioned business applications.

Now, as shown in FIG. 1, transaction voucher management system 1 in accordance with the embodiment of the present invention is provided with a data recording section 10, definition management section 11, voucher processing section 12, and transaction management section 13. Transaction voucher management system 1 may be constituted of a computer system like business system 2A. Although transaction voucher management system 1 is shown as a computer system different from business system 2A in this embodiment, it may be possible to configure transaction voucher management system 1 inside the computer system identical to business system 2A.

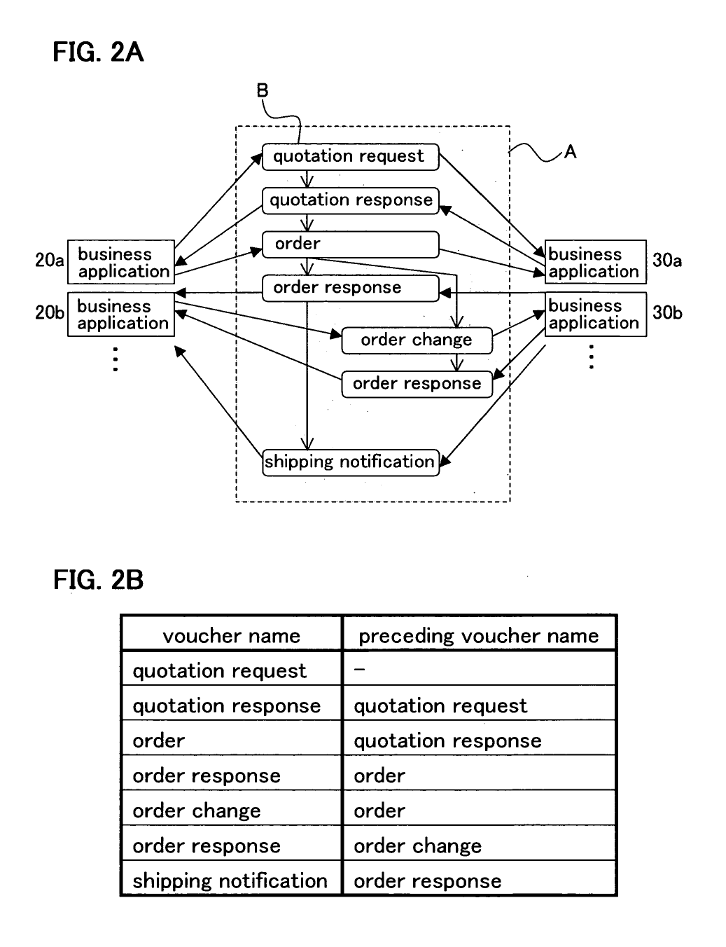

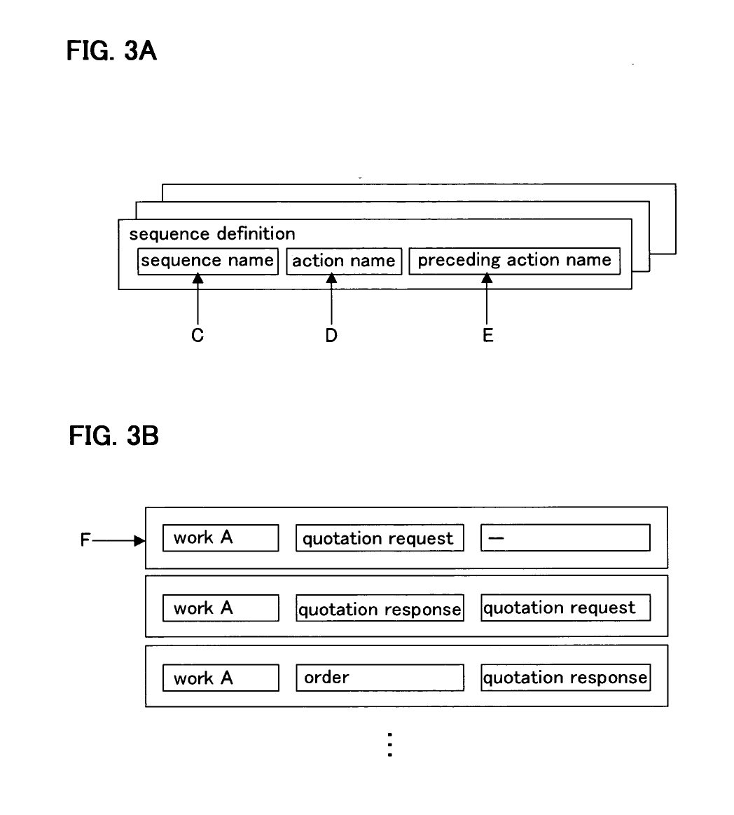

First, data recording section 10 is a database, in which a variety of data for use in this transaction voucher management system 1 are recorded and managed. A sequence definition data 100 and a sequence log data 101 are recorded in data recording section 10. Here, sequence definition data 100 is a data which defines a work process procedure (work sequence) executed between business systems (2A, 3A, . . . ) or between business applications (20a, 30a, . . . ) on a work-by-work basis. FIGS. 2A, 2B show diagrams for illustrating such a work sequence. Also, FIGS. 3A, 3B show a diagram for illustrating a sequence definition data 100.

FIG. 2A shows a diagram exemplarily illustrating a work flow executed between business applications. FIG. 2B shows relation between a voucher and a preceding voucher. The example shown in FIG. 2A is a work case that business applications (20a, 20b, . . . ) purchase commodities from business applications (30a, 30b, . . . ). In this case, like in a case of non-electronic transaction, an action of ‘quotation request’ shown as ‘B’ and the subsequent actions shown in the figure are performed successively to complete the work. Here, each behavior such as ‘quotation request’ shown as ‘B’ is referred to as an action. Each action is performed by transmitting a voucher (voucher data 5). Also, each procedure by which these actions are executed is referred to as sequence (‘A’ shown in FIG. 2A). Here, in FIG. 2A, a single sequence is executed by a plurality of business applications. However, it may also be possible for the single sequence to be executed by either a single business application or a plurality of business systems (2A, 2B, . . . )

As shown in FIG. 2B, this sequence can be defined by determining a voucher (action) processed at one action before the voucher of interest, against each voucher (action). Hereinafter, the voucher (action) processed at one action before the voucher of interest will simply be referred to as a preceding voucher (preceding action). By way of example, in FIG. 2B, it is represented that the ‘quotation request’ voucher is processed prior to the ‘quotation response’ voucher. Additionally, no preceding voucher is existent with regard to a voucher which is transmitted (processed) for the first time in each work.

The above-mentioned sequence definition data 100 defines each work sequence in the form of determining the preceding action thereof for each action to be performed in the work concerned. FIG. 3A shows a diagram conceptually illustrating a sequence definition data 100. As shown in this figure, a sequence name (‘C’ in the figure), an action name (‘D’ in the figure), and a preceding action (‘E’ in the figure) constitute a minimum unit of sequence definition data 100. Here, each sequence name is assigned to each work sequence. In the example shown in FIG. 2A, one particular name is assigned to the sequence shown as ‘A’. Accordingly, each work is given sequence definitions the number of which equals to the number of actions to be performed in the work concerned.

FIG. 3B shows a diagram illustrating sequence definition data 100 for the work exemplarily shown in FIGS. 2A, 2B. Here, a sequence name of ‘work A’ is assigned to the sequence shown as ‘A’ in FIG. 2A. The data shown as ‘F’ in FIG. 3B is an example of sequence definition data 100 with regard to the ‘quotation request’, that is, the first action in ‘workA’. Following the above sequence data, totally seven sequence definition data 100 are defined with regard to this ‘work A’, though the complete data are not shown in FIG. 3B.

The above-mentioned sequence definition data 100 is set and modified by definition management section 11, which will be described later.

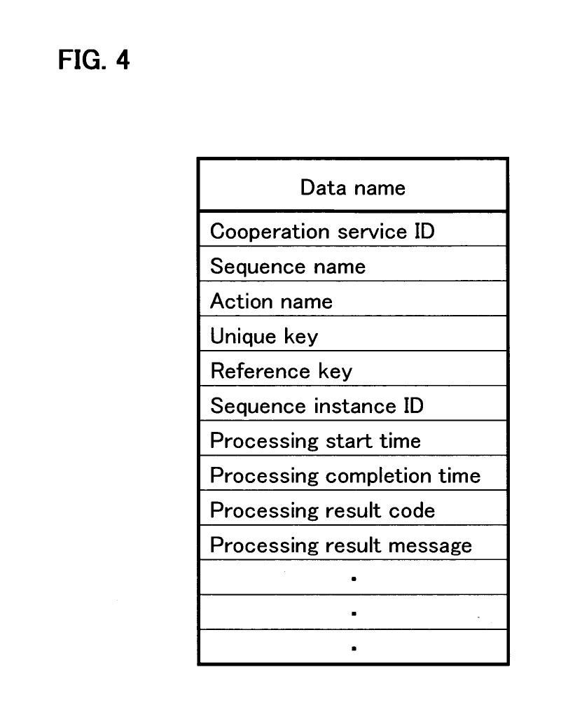

Next, sequence log data 101 records information of the actions having been processed by transaction voucher management system 1. More specifically, information related to voucher data 5 having been received and processed is recorded. FIG. 4 shows a diagram illustrating exemplary data items recorded in sequence log data 101, which includes data items shown in FIG. 4 against each voucher data 5 having been processed. First, a ‘cooperation service ID’ is an identification number assigned for the entire actions (vouchers). The identification number given to the first action of a certain work is handed over to the entire series of actions (vouchers) which are performed subsequently in response to the fist action. This identification number is set into each ‘sequence instance ID’ field (refer to FIG. 4) in sequence log data 101 for the action (voucher) concerned and the subsequent actions.

A ‘sequence name’ and an ‘action name’ signify a sequence (work) name to which the processed voucher data 5 belongs, and an action name performed by use of the voucher data 5 of interest, respectively. Further, a ‘unique key’ is an identification number of the voucher (data 5) of interest, and a ‘reference key’ is an identification number of the preceding voucher data prior to the voucher data concerned. In other words, the ‘reference key’ is the unique key of the preceding voucher.

An example of the ‘unique key’ and the ‘reference key’ is illustrated in the following: In case of an order voucher, and the preceding voucher of the order voucher being a quotation response voucher, the unique key of the order voucher concerned may be an ‘order number’, as well as the reference key of the order voucher may be a ‘quotation response number’. The ‘sequence instance number’ is a cooperation service ID given to the first voucher (action) in the sequence of the voucher concerned, as described above. A series of vouchers (actions) belonging to an identical sequence have an identical sequence instance ID, and this identical sequence instance ID is recorded against each voucher (action) in sequence log data 101.

Sequence log data 101 described above is recorded by voucher processing section 0.12, which will be explained later. Sequence log data 101 is used when voucher processing section 12 performs a voucher consistency check.

Next, definition management section 11 of transaction voucher management system 1 plays a role of managing sequence definition data 100 for each work processed in transaction voucher management system 1. Based on an operation by an administrator of transaction voucher management system 1, definition management section 11 sets or modifies sequence definition data 100. A typical procedure for setting sequence definition data 100 will be described later. In short, definition management section 11 provides the operator with a wizard-type interface, enabling the operator to set or modify sequence definition data 100 easily. Also, because transaction voucher management system 1 performs processing for a plurality of work types, it is possible to set respective sequence definition data 100 for the plurality of work types, needless to say. Definition management section 11 is constituted of a program having a processing description for execution, a control unit for execution of the processing based on the program, a display unit for the operator, etc.

Next, voucher processing section 12 is a major section in transaction voucher management system 1, having functions of relaying voucher data 5 transmitted between business applications, checking the consistency of voucher data 5 related to the work process procedure, and transmitting voucher data 5 to the other party when the consistency is confirmed. Typical processing executed by voucher processing section 12 will be described later. Voucher processing section 12 is constituted of a program having a processing description for execution, a control unit for execution of the processing based on the program, etc.

Further, transaction management section 13 performs history management of the transaction vouchers and work progress management, with regard to the entire work performed through transaction voucher management system 1. More specifically, upon request from the operator, transaction management section 13 provides the operator with information related to the history management of the transaction vouchers or progress control, based on the above-mentioned sequence log data 101. For example, based on a data to which voucher in a certain work the history information has been recorded as sequence log data 101, transaction management section 13 can inform the operator of the progress status of the work concerned. Transaction management section 13 is constituted of a program having a processing description for execution, a control unit for execution of the processing based on the program, a display unit for the operator, etc.

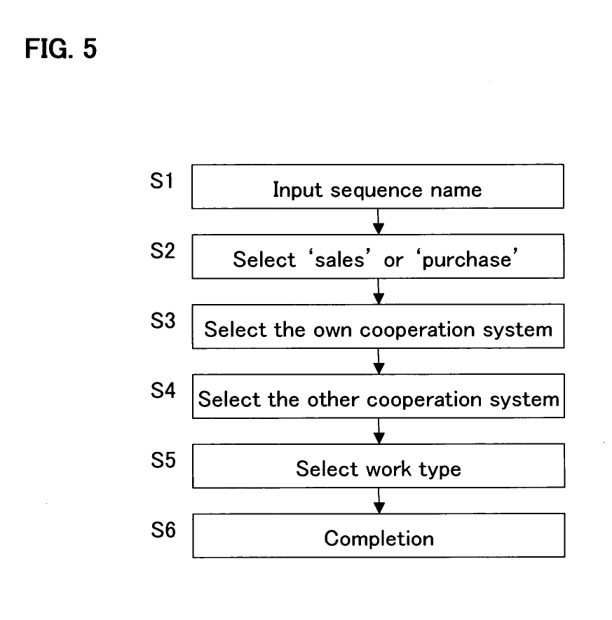

FIG. 5 shows a flowchart illustrating an exemplary operation procedure in case of setting sequence definition data 100 by a definition management section 11. When defining a sequence, as described earlier, definition management section 11 provides the operator with a wizard-type interface screen. The operator performs operations sequentially according to the instructions displayed on the screen.

First, with regard to the work the sequence of which is to be defined, definition management section 11 displays a screen prompting an operator to input a sequence name of the work concerned, and then receives the input from the operator (step S1 in FIG. 5). Next, definition management section 11 displays a screen for prompting the operator to select the content of the work, either ‘sales’ or ‘purchase’, and receives the selection from the operator (step S2 in FIG. 5). Next, definition management section 11 displays a screen for selecting the system on the side of transaction voucher management system 1, namely the system constituting business system 2A (or the business application in business system 2A). More specifically, the screen indicates system names of a plurality of systems for general use (hereafter these systems are referred to as cooperation systems), including package software systems having been developed for performing particular work and sold in a commercial market. Using this screen, the operator selects a cooperation system constituting the business system (business application) for executing the work for which the operator is going to perform the sequence definition (step S3 in FIG. 5).

Similarly, definition management section 11 displays a selection screen with regard to the cooperation system on the other transaction party of the work concerned, by displaying the similar contents explained above. The operator then selects the cooperation system name(s) constituting the business system (business application) of the other transaction party (step S4 in FIG. 5). On receipt of the above-mentioned inputs, definition management section 11 selects work contents (work types), which can be performed commonly in both the own party's cooperation system and the other party's cooperation system, based on the information of each cooperation system having been registered in advance. For example, in the aforementioned step S2 shown in FIG. 5, when ‘purchase’ is selected, ‘quotation’, ‘quotation and purchase’, etc. are selected as the work types which can be performed in common.

Definition management section 11 then displays the selected work types which can be performed in common, and prompts the operator to select from among the displayed work types. The operator then selects the contents which fit for the work of which the sequence definition is in progress (step S5 in FIG. 5).

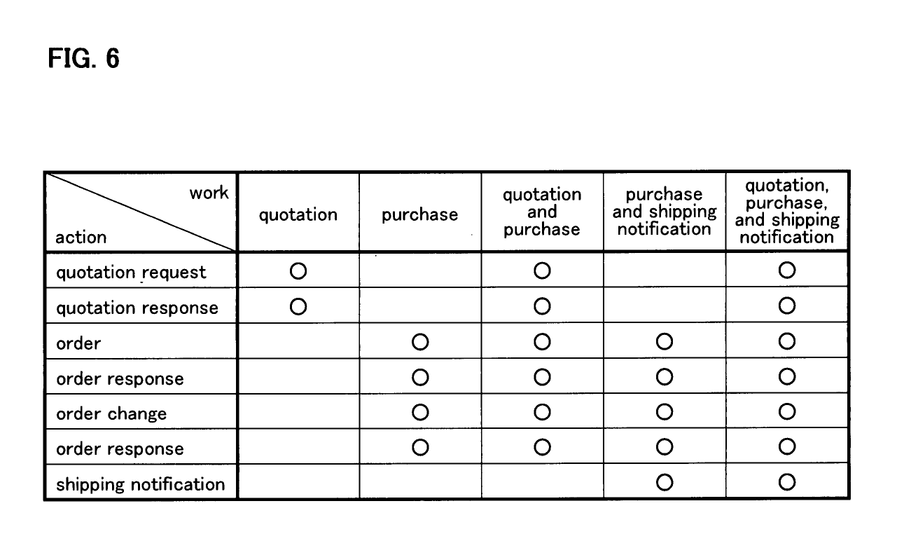

FIG. 6 shows a diagram exemplarily illustrating the actions and the sequence thereof to be performed in each work type described above. In this figure, each action marked by a circle denotes the action to be performed for each work, and an action shown in an upper row is to be executed in earlier order. Definition management section 11 is provided with such information as shown in FIG. 6 in advance. According to the work type selected by the operator, definition management section 11 generates sequence definition data 100 based on the information shown in FIG. 6, and stores the generated data into data recording section 10 (step S6 in FIG. 5). More specifically, definition management section 11 sets the aforementioned input sequence name, each action name concerned and each preceding action name for each action belonging to the selected work type, based on the information such as shown in FIG. 6. Thus, sequence definition data 100 as shown in FIGS. 3A, 3B is constructed for the work for which the definition is intended.

The above-mentioned sequence definition is performed prior to the actual transaction execution. Further, modification of sequence definition data 100 once having been set can be performed using the same interface, whenever necessary. As having been described, in transaction voucher management system 1, the sequence definition and the modification of the sequence definition for checking transaction work process procedure can be performed with an easy operation.

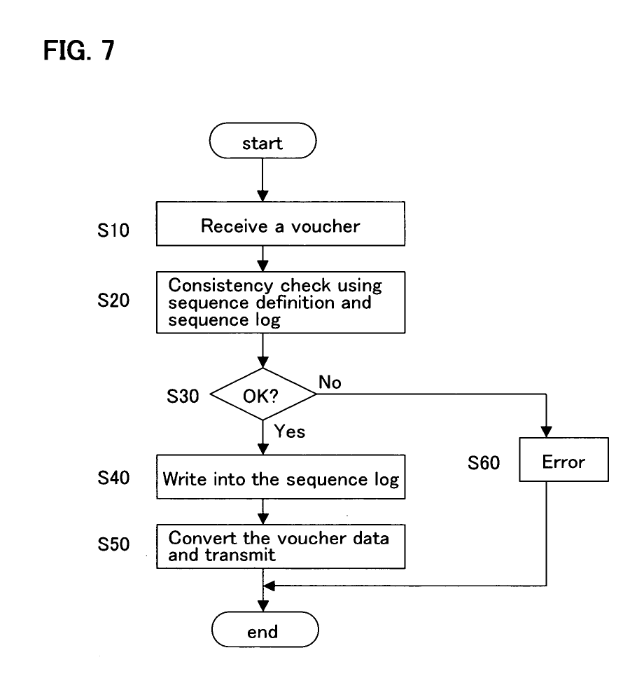

Next, FIG. 7 shows a flowchart exemplarily illustrating the processing contents performed in transaction voucher management system 1, when a transaction is being performed between business applications. Typically, FIG. 7 broadly shows the processing performed when voucher processing section 12 in transaction voucher management system 1 receives voucher data 5. First, when a voucher data (voucher data 5) is to be transmitted from a business application (20a, 30a, . . . ) to another business application in the other party (20a, 30a, . . . ), transaction voucher management system 1 receives the voucher data 5 of interest before voucher data 5 is transmitted to the other party (step S10 in FIG. 7).

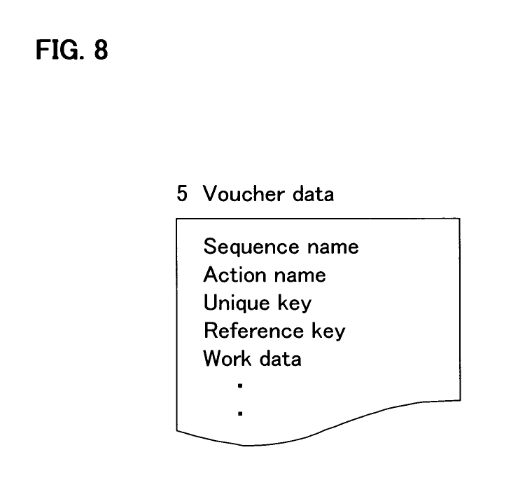

FIG. 8 shows a diagram exemplarily illustrating data items included in a voucher data 5. As shown in FIG. 8, voucher data 5 includes ‘sequence name’, ‘action name’, ‘unique key’, and ‘reference key’ as identification information, which precede the ‘work data’ related to the work of interest. ‘Sequence name’ is a name assigned to work type to which the voucher data 5 of interest belongs, which is identical to the ‘sequence name’ in sequence log data 101 having been described referring to FIG. 4. Further, ‘action name’, ‘unique key’, and ‘reference key’ respectively represent an action name caused by voucher data 5, an identification number of voucher data 5, and an identification number of voucher data 5 preceding the voucher data 5 of interest. These data items signify the same as the data items in sequence log data 101.

On receipt of voucher data 5, voucher processing section 12 performs consistency check of the received voucher data 5, based on the received voucher data 5 and the aforementioned sequence definition data 100 and sequence log data 101 (step S20 in FIG. 7). Details of this processing will be described later. Through this processing, consistency is checked on whether the received voucher data is transmitted conforming to a correct procedure defined in sequence definition data 100, in other words, whether the action by means of voucher data 5 are being performed conforming to the correct procedure.

As a result of this processing, when it is decided the above-mentioned consistency is satisfied, namely when it is decided the voucher data 5 of interest have been transmitted conforming to the correct procedure (‘Yes’ in step S30 shown in FIG. 7), voucher processing section 12 writes the information related to the received voucher data 5 of interest into the above-mentioned sequence log data 101 (step S40 in FIG. 7). Voucher processing section 12 then converts the voucher data 5 of interest into a data suitable for the business application (20a, 30a, . . . ) of the other party, typically converts the voucher data 5 of interest by processing the data by means of data format conversion, character code conversion, etc. Voucher processing section 12 then transmits the converted voucher data 5 to the business application (20a, 30a, . . . ) of the other party (step S50 in FIG. 7). Thus, the processing for the received voucher data 5 is completed.

Meanwhile, in the aforementioned consistency check, when it is decided the voucher data 5 of interest is not transmitted conforming to the correct procedure, in other words the work related to the voucher data 5 of interest is not performed conforming to the correct procedure (‘No’ in step S30 shown in FIG. 7), voucher processing section 12 determines an error has occurred. Accordingly, voucher processing section 12 terminates the processing for the voucher data 5 of interest, and notifies this condition to the business application (20a, 20b, . . . ) in business system 2A performing the work related to the voucher data 5 of interest (step S60 in FIG. 7). Here, this error notification may be transmitted also to the business application (30a, 30b, . . . ) of the other party with which business application (20a, 20b, . . . ) in the business system 2A is transacting.

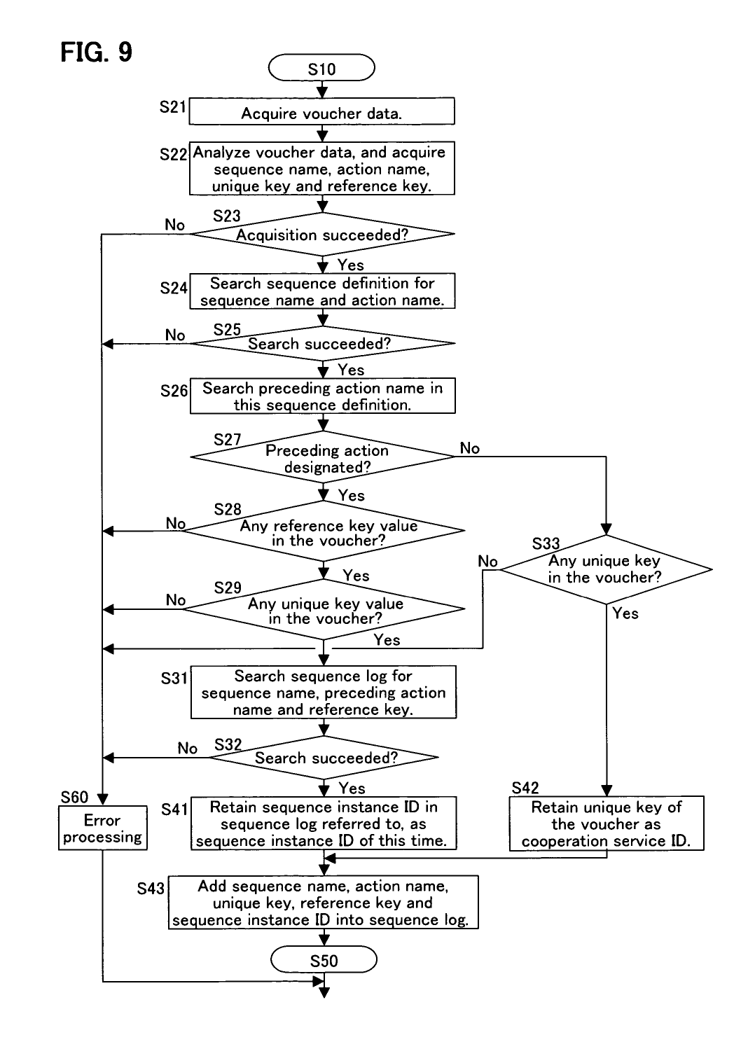

FIG. 9 shows a flowchart illustrating the processing performed by a voucher processing section 12 in more detail. More specifically, the details of the processing of checking the consistency (steps S20, S30) and writing into the sequence log (step S40) are shown. When voucher data 5 is received in voucher processing section 12 (step S10), first, each data included in voucher data 5 is acquired (step S21 in FIG. 9). The acquired data is then analyzed, and the aforementioned data of ‘sequence name’, ‘action name’, ‘unique key’, and ‘reference key’ are acquired from voucher data 5. (step S22 in FIG. 9). Here, as having been explained referring to FIG. 8, ‘sequence name’, ‘action name’, ‘unique key’, and ‘reference key’ have already prepared in the received voucher data 5, according to the embodiment of the present invention. However, there may be a case that the received voucher does not include ‘sequence name’ and ‘action name’. Also, there may be a case that ‘unique key’ and ‘reference key’ are not stored in fixed positions. In such cases, voucher processing section 12 executes a processing for identifying these data from other information included in the voucher concerned, by use of threading information defined in advance, and the like.

When this acquisition is successful (‘Yes’ in step S23 shown in FIG. 9), sequence definition data 100 is searched for the acquired sequence name and action name (step S24 in FIG. 9). More specifically, sequence definition data 100 defined for each action, which has been explained referring to FIGS. 3A, 3B, is searched for the data having the acquired sequence name and action name.

When the search is successful (‘Yes’ in step S25 shown in FIG. 9), a preceding action name (‘E’ in FIG. 3A) included in the searched sequence definition data 100 is searched (step S26 in FIG. 9). As a result of this search, if the preceding action has been designated (set), the preceding action name concerned is acquired (‘Yes’ in step S27 shown in FIG. 9). Thereafter, it is checked whether a reference key value is existent in the acquired voucher data 5 (step S28 in FIG. 9), and also it is checked whether a unique key value is existent in the acquired voucher data 5 (step S29 in FIG. 9).

If both the above-mentioned key values are existent (‘Yes’ in step S28, and ‘Yes’ in step S29 in FIG. 9), the aforementioned sequence log data 101 is searched for the acquired sequence name, preceding action name, and reference key (step S31 in FIG. 9). More specifically, sequence log data 101, in which data have been recorded for each voucher data 5 exemplarily shown in FIG. 4, is searched for a data which has the same sequence name as the acquired sequence name, the same action name as the acquired preceding action name, and the same unique key as the acquired reference key.

The unique key of voucher data 5 of interest is retained as cooperation service ID, and at the same time, when the search is successful, namely when sequence log data 101 matching with the above-mentioned condition is found (‘Yes’ in step S32 shown in FIG. 9), the sequence instance ID in the searched sequence log data 101 is acquired. This acquired sequence instance ID is then retained as sequence instance ID of voucher data 5 received this time (step S41 in FIG. 9). Next, the sequence name, the action name, the unique key and the reference key in voucher data 5 received this time, together with the above-mentioned retained cooperation service ID and the sequence instance ID, are recorded into data recording section 10 as sequence log data 101 of voucher data 5 received this time (step S43 in FIG. 9). These data are to be used when a succeeding voucher data 5 transmitted subsequently to the voucher data 5 of interest is processed, as sequence log data 101 related to the preceding action.

On completion of the processing described above, the process is shift to a data conversion and transmission step (S50) of the received voucher data 5, as shown in FIG. 7.

Meanwhile, in the aforementioned step S27 in FIG. 9, if a preceding action name of the searched sequence definition data 100 is not designated (set) (‘No’ in step S27 shown in FIG. 9), namely if the received voucher data 5 is the first voucher data 5 of the work process procedure, it is confirmed that a unique key value is existent in voucher data 5 (‘Yes’ in step S33 shown in FIG. 9), and the unique key of the voucher data 5 of interest is retained as cooperation service ID (step S42 in FIG. 9). This unique key signifies an identification number, which becomes the ‘sequence instance ID’ having been described referring to FIG. 4, and becomes the number representing a series of work starting from the received voucher data 5. As described earlier, the sequence instance ID is handed over to each voucher data 5 of a series of work concerned. Thereafter, the process is shifted to the aforementioned step S43 shown in FIG. 9, in which sequence log data 101 is recorded for the voucher data 5 of interest in a similar way. The unique key retained as the above-mentioned cooperation service ID is recorded as ‘cooperation service ID’ and ‘sequence instance ID’.

Further, in each of the aforementioned steps S23, S25, S28, S29, S32 and S33 shown in FIG. 9, when the processing result is ‘No’, voucher processing section 12 determines that an error occurred, and executes the error processing described as a step S60 shown in FIG. 7. Here, although the processing is terminated after the error processing (step S60) in the examples illustrated based on FIGS. 7 and 9, it may also be possible that the result be recorded even in case the error processing is performed, as sequence log data 101.

As having been described, the processing of voucher data 5 is performed while an actual electronic transaction is in progress. Moreover, in transaction voucher management system 1 according to the embodiment of the present invention, history management of the processing having been completed can be performed in the aforementioned transaction management section 13. As described before, in this transaction voucher management system 1, information related to voucher data 5 having been processed remains in sequence log data 101. Therefore, it is possible to manage information handled by the entire business applications employing this transaction voucher management system 1 in a unified way. Further, as described above, because an identical sequence instance ID is assigned to a series of actions in the work concerned, data can easily be searched for the sequence instance ID for extraction, enabling easy progress management and history management for each work in a short time. Also, as having been described, in case an error result is retained in sequence log data 101 when error processing is performed, it is possible to perform error analysis, as well as work analysis causing a bottleneck.

Also, as having been described, by use of transaction voucher management system 1 according to the embodiment of the present invention, consistency of voucher data 5, communicated between business applications, in regard to the work process procedure is checked prior to the transmission to the other business application. Therefore, an error occurred in the work process procedure can be detected in an early stage, and a loss caused by the error can be reduced. According to transaction voucher management system 1, even when addition or modification to the work process procedure occurs, it is only necessary to modify the aforementioned sequence definition data 100, in regard to the consistency check of voucher data 5 related to the work process procedure. The operation can be performed using the aforementioned wizard-type interface. Accordingly, modification work becomes substantially easier than in the conventional art. Moreover, information on the business application provided in a plurality of business system can be managed in a unified way.

In the embodiment of the present invention, the description is based on a case of transacting between companies. However, it is also possible to apply the transaction voucher management system according to the present invention when transaction is performed between a plurality of business applications within a company. Also, according to the embodiment of the present invention described above, the transaction voucher management system has been provided for a single business system. However, a similar transaction voucher management system may be provided in each plurality of business systems, or a single transaction voucher management system may be provided for a plurality of business systems. Further, according to the embodiment of the present invention, transaction voucher management system 1 has been placed as a system in business system 2A. However, it is also possible to place this transaction voucher management system as a system separate from the entire business systems and business applications employing the transaction voucher management system.

To summarize the effects of the present invention, an error can be detected earlier, because the consistency of a transaction voucher for transmission is checked before the voucher is actually processed in a business application. For the modification of the system in regard to the consistency check when modifying a work process procedure, program modification required in each business application becomes easy, because only the aforementioned definition data is required to modify. Further, transaction history management can be performed in a unified manner, because transaction data on the entire business applications relaying a transaction are recorded in the transaction voucher management system.

The foregoing description of the embodiments is not intended to limit the invention to the particular details of the examples illustrated. Any suitable modification and equivalents may be resorted to the scope of the invention. All features and advantages of the invention which fall within the scope of the invention are covered by the appended claims.

What is claimed is:

1. A transaction voucher management method in a computer relaying a transaction voucher data to be transmitted between business applications through a network, comprising:
a first step in which the computer receives the transaction voucher data transmitted from the business application;
a second step in which the computer checks the consistency of the received transaction voucher data with regard to a work process procedure, based on both a definition data defining in advance the work process procedure performed by transmitting the transaction voucher data, and a log data having recorded information related to the transaction voucher data received in the past;
a third step in which, on deciding there is a consistency by the check performed in the second step, the computer records information related to the received transaction voucher data as the log data, and transmits said transaction voucher data to the business application provided on a destination side; and
a fourth step in which, on deciding there is an inconsistency by the check performed in the second step, the computer performs error processing.

2. The transaction voucher management method according to claim 1,
wherein the consistency check performed in the second step comprises:
a step in which the computer determines a preceding transaction voucher data to have been processed prior to the processing of the received transaction voucher data, based on the definition data; and
a step in which the computer checks whether the information related to the determined preceding transaction voucher data is recorded as the log data.

3. The transaction voucher management method according to either claim 1 or 2,
wherein the information recorded as log data in the third step includes information for identifying a work performed based on the received transaction voucher data.

4. A program for causing a computer relaying a transaction voucher data transmitted between business applications through a network, to execute processing for transaction voucher management, said management processing comprising:
a first step of receiving the transaction voucher data transmitted from the business application;
a second step of checking the consistency of the received transaction voucher data with regard to a work process procedure, based on both a definition data defining in advance the work process procedure performed by transmitting the transaction voucher data, and a log data having recorded information related to the transaction voucher data received in the past;
a third step of recording the information related to the received transaction voucher data as the log data, and transmitting said transaction voucher data to the business application provided on a destination side, on deciding that there is a consistency by the check performed in the second step; and
a fourth step of performing error processing, on deciding that there is an inconsistency by the check performed in the second step.

5. The program according to claim 4,
wherein the consistency check performed in the second step comprises:
a step of determining a preceding transaction voucher data to have been processed prior to the processing of the received transaction voucher data, based on the definition data; and
a step of checking whether the information related to the determined preceding transaction voucher data is recorded as the log data.

6. The program according to either claim 4 or 5,
wherein the information recorded as log data in the third step includes information for identifying a work performed based on the received transaction voucher data.

7. A recording medium recording a program for causing a computer relaying a transaction voucher data transmitted between business applications through a network, to execute processing for transaction voucher management, said management processing comprising:
a first step of receiving the transaction voucher data transmitted from the business application;
a second step of checking the consistency of the received transaction voucher data with regard to a work process procedure, based on both a definition data defining in advance the work process procedure performed by transmitting the transaction voucher data, and a log data having recorded information related to the transaction voucher data received in the past;
a third step of recording the information related to the received transaction voucher data as the log data, and transmitting said transaction voucher data to the business application provided on a destination side, on deciding that there is a consistency by the check performed in the second step; and
a fourth step of performing error processing, on deciding that there is an inconsistency by the check performed in the second step.

8. The recording medium according to claim 7,
wherein the consistency check performed in the second step comprises:
a step of determining a preceding transaction voucher data to have been processed prior to the processing of the received transaction voucher data, based on the definition data; and
a step of checking whether the information related to the determined preceding transaction voucher data is recorded as the log data.

9. The recording medium according to either claim 7 or 8,
wherein the information recorded as log data in the third step includes information for identifying a work performed based on the received transaction voucher data.
